(19) United States
(12) Patent Application Publication
(10) Pub. No.: US 2024/0075564 A1
(43) Pub. Date: Mar. 7, 2024

(54) BOLT REMOVAL TEMPLATE AND METHODS OF USE THEREOF

(71) Applicant: Jeffrey Del Rossa, Pittsburgh, PA (US)

(72) Inventor: Jeffrey Del Rossa, Pittsburgh, PA (US)

(21) Appl. No.: 17/929,490

(22) Filed: Sep. 2, 2022

(51) Int. Cl. B23P 19/04

(52) U.S. Cl. CPC B23P 19/04

(57) ABSTRACT

Embodiments relate to a bolt removal template that can be used remove failed bolts from Doser Valve mounting bolt holes of a DEF fuel tank or other suitable bolt holes. The bolt removal template comprises a plate and an expandable flange. The plate can have a plurality of apertures. The plate can have a top and bottom. The flange can be positioned on the bottom of the plate and adjacent to one of the apertures.

### FIELD OF THE INVENTION

Embodiments relate to a bolt removal or (DEF tank and assembly salvage) template generally and methods of use thereof. More particularly, embodiments relate to a bolt removal template that can be used to remove failed bolts from bolt holes of a DEF fuel tank or other suitable bolt holes and method of use thereof.

### BACKGROUND OF THE INVENTION

Over time, bolts used to secure the Doser Valve to the DEF fuel tank can become corroded from exposure to moisture, road salt, oxygen, and other metal contaminating elements. Ultimately, the Doser Valve mount bolt can fail (e.g. crack, break, etc.) when a technician attempts to diagnose, remove, repair, or replace it, wherein the broken mounting bolt becomes lodged within the bolt hole. Typical methods for removing the failed bolt involve using an electric or air powered drill to remove the damaged fastener. As the user employs the drill, the drill bit within the bolt hole will wander (i.e. move laterally) due to the angular broken surface of the fastener remnant and misalign within the failed bolt. Wandering is undesirable because it can make it more difficult to drill out the bolt efficiently. In addition, the wandering drill bit can make contact with and damage the internal walls, e.g., threads of the bolt hole. Accordingly, there is a clear need for a device that provides assistance in removing failed bolts, salvaging the titanium DEF tank, and restoring environmental benefits in the use of bio fuel.

### SUMMARY OF THE INVENTION

Embodiments relate to a bolt removal template that can be used to remove failed bolts from Doser Valve mounting bolt holes of a DEF fuel tank or other suitable bolt holes. The bolt removal template comprises a plate and an expandable flange. The plate can have a plurality of apertures. The plate can have a top and bottom. The flange can be positioned on the bottom of the plate and adjacent to one of the apertures.

In some embodiments, the plurality of apertures can include four apertures.

In some embodiments, at least one aperture can have an internal threaded portion.

In some embodiments, the plate can be configured to engage with a fuel tank housing wherein the fuel tank housing can have a fuel line and a bolt hole.

In some embodiments, the plate can engage with the fuel tank housing wherein the flange can be positioned inside the fuel line.

In some embodiments, the bolt removal template can further comprise a threaded bolt and a mechanical fastener. The threaded bolt can be positioned within the flange. The mechanical fastener can be configured to threateningly engage the bolt, wherein engaging the fuel tank housing involves actuating the mechanical fastener.

In some embodiments, the flange can comprise an annular member having a notch formed in a peripheral portion thereof.

In some embodiments, the flange can comprise material capable of elastic deformation.

In some embodiments, the flange can comprise nylon.

In some embodiments, actuating the mechanical fastener can cause the flange to expand in a direction that is radial to a longitudinal axis of the threaded bolt.

In some embodiments, expansion of the flange can secure the template to the fuel tank housing and/or at least partially obstructs the fuel line.

In some embodiments, the expansion of the flange can hold the plate stationary relative to the fuel tank housing.

In some embodiments, one aperture can be aligned with the bolt hole.

In some embodiments, the plurality of apertures can include a first bolt aperture, a second bolt aperture, a third bolt aperture, and a fuel line aperture. Each of the first bolt aperture, the second bolt aperture, and the third bolt aperture can be positioned on the plate so as to align or co-register with a first bolt hole, a second bolt hole, and a third bolt hole, respectively, of a fuel tank housing when the plate bottom is placed adjacent to the fuel tank housing. The fuel line aperture can be positioned on the plate so as to align or co-register with a fuel line of the fuel tank housing when the plate bottom is placed adjacent to the fuel tank housing.

An exemplary embodiment relates to a method for removing a failed Doser Valve mounting bolt from the DEF tank housing with a bolt removal template. The fuel tank housing can have a fuel line and a bolt hole. The embodiment of the bolt removal template can have a plate and a flange. The plate can have a plurality of apertures. The plate can have a top and bottom. The flange can be positioned on the bottom of the plate and adjacent to one of the apertures. The method can involve placing the plate adjacent to the fuel tank housing such that the flange is positioned inside the fuel line and one aperture is aligned or co-registered with the bolt hole, the bolt hole containing a failed bolt. The method can involve inserting a drill bit through the aligned or co-registered aperture so as to make contact with the failed bolt. The method can involve allowing the bolt removal template to maintain the drill bit in proper alignment before, during, and/or after actuation of the drill bit. Actuating the drill bit can involve causing the drill bit to rotate about an axis of the drill bit and/or to move in a direction parallel to the axis of the drill bit. Proper alignment can include maintaining the drill bit at an orientation that is co-axial with the bolt hole and/or preventing the drill bit from moving laterally so as to misalign or not co-register with the bolt hole. The method can involve actuating the drill bit. In some embodiments, the method can involve securing the plate to the fuel tank housing.

In some embodiments of the method, securing the plate to the fuel tank housing can force the one aperture to be aligned or co-registered with the bolt hole during actuation of the drill bit.

In some embodiments of the method, actuating the drill bit can bore out at least a portion of the failed bolt.

In some embodiments of the method, actuating the drill can involve actuating a drill in mechanical connection with the drill bit.

In some embodiments, the method can involve causing the flange to expand to secure the plate to the fuel tank housing and/or at least partially obstruct the fuel line.

### BRIEF DESCRIPTION OF THE DRAWINGS

The above and other objects, aspects, features, advantages, and possible applications of the present innovation will be more apparent from the following more particular description thereof, presented in conjunction with the following drawings. Like reference numbers used in the drawings may identify like components.

FIG. 1 is a bottom perspective view of an embodiment of a bolt removal template.

FIG. 2 is a top view of an embodiment of a bolt removal template.

FIG. 3 is a bottom view of an embodiment of a bolt removal template.

FIG. 4 is a right side view of an embodiment of a bolt removal template.

FIG. 5 is a left side view of an embodiment of a bolt removal template.

FIG. 6 is a rear view of an embodiment of a bolt removal template.

FIG. 7 is a front view of an embodiment of a bolt removal template.

FIG. 8 is a rear view cut-away of an embodiment of a bolt removal template configured to fuel tank housing. The axis of the cut-away is depicted in FIG. 2.

FIG. 9 is a top perspective view of an embodiment of a fuel tank housing.

FIG. 10 is a top view of an embodiment of a bolt removal template configured to an embodiment of a fuel tank housing.

FIG. 11 is a top view of an embodiment of a bolt removal template configured to an embodiment of a fuel tank housing.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

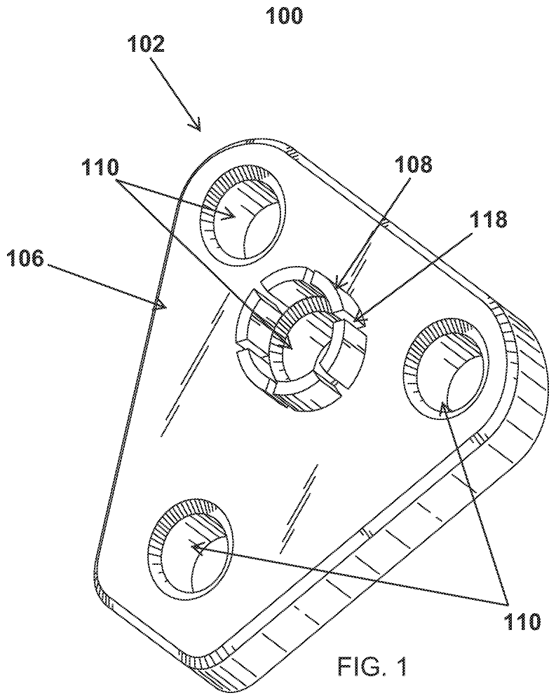

Embodiments relate to a bolt removal template 100 that can be used remove failed bolts from Doser Valve mounting bolt holes of a DEF fuel tank or other suitable bolt holes. As seen in FIG. 1, the bolt removal template 100 comprises a plate 102 and a flange 108. As will be explained herein, he flange 108 can be an expanding flange. The plate 102 can have a plurality of apertures 110. The plate 102 can have a top 104 and bottom 106. The flange 108 can be positioned on the bottom 106 of the plate 102 and adjacent to one of the apertures 110.

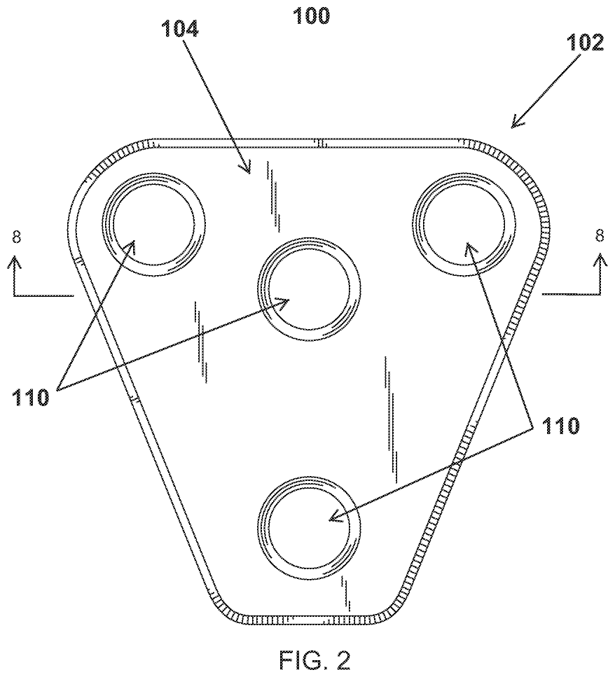

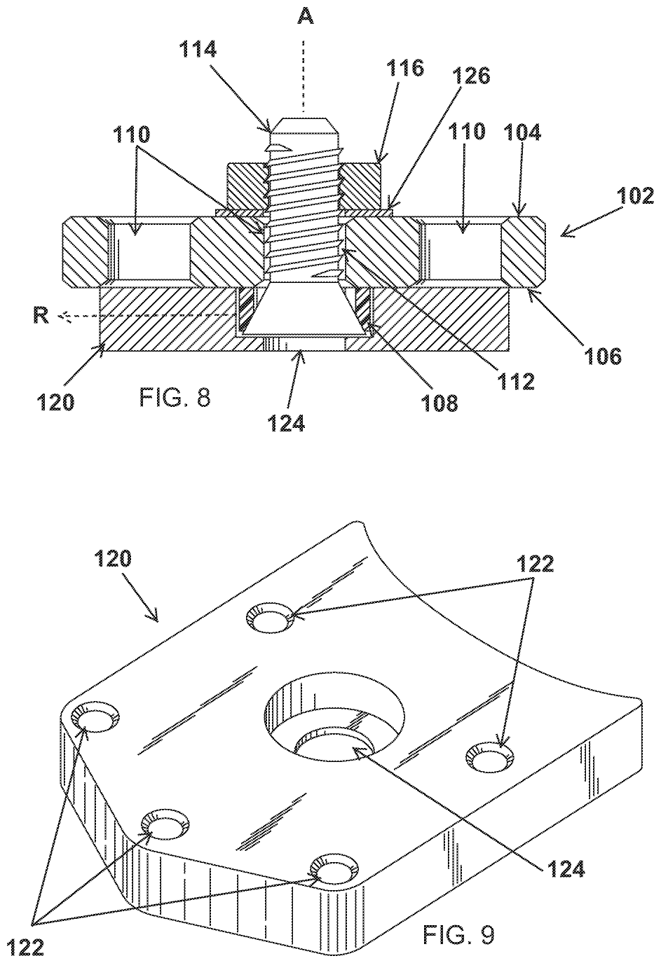

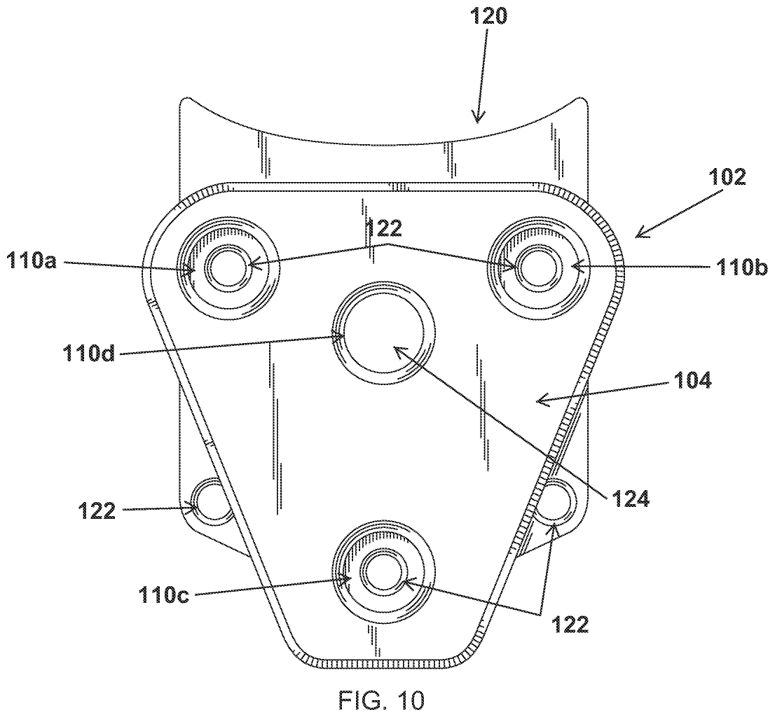

The profile of the plate 102 can be any type of shape, e.g. circle, triangle, square etc. As seen in FIG. 2, the plate 102 can have at least three corners where at least one corner of the plate 102 can be rounded or flattened. The top 104 and/or bottom 106 of the plate 102 can be flat or slightly convex. The top 104 and/or bottom 106 of the plate 102 can have a chamfer along at least a portion of the periphery of the plate 102. As seen in FIGS. 8 and 10, it is contemplated that the size and shape of the plate 102 can be designed such that the bottom 106 of the plate 102 can lie flat against the fuel tank housing 120. The plate 102 can be made of any material, e.g. metal, metal alloy, wood, plastic, rubber, etc.

As seen in FIG. 2, the plate 102 can have at least one aperture 110. In some embodiments, the plate 102 has a plurality of apertures 110 (e.g. 2, 3, 4, etc.). As seen in FIG. 8, at least one aperture 110 can have an internal threaded portion 112 for receiving a bolt 114 having a complementary external threaded portion. Alternatively, as seen in FIG. 1, the internal portion of the aperture(s) 110 can be smooth rather than threaded. The plurality of apertures 110 can be positioned anywhere on the plate 102. In some embodiments, at least one aperture 110 is positioned towards the center of the plate 102 with the remaining apertures 110 positioned towards an outer edge or edges. As will be explained herein and seen in FIG. 10, the plurality of apertures 110 can be positioned on the plate 102 such that the bolt removal template 100 can be configured to engage with a fuel line 124 and bolt hole(s) 122 of a fuel tank housing 120.

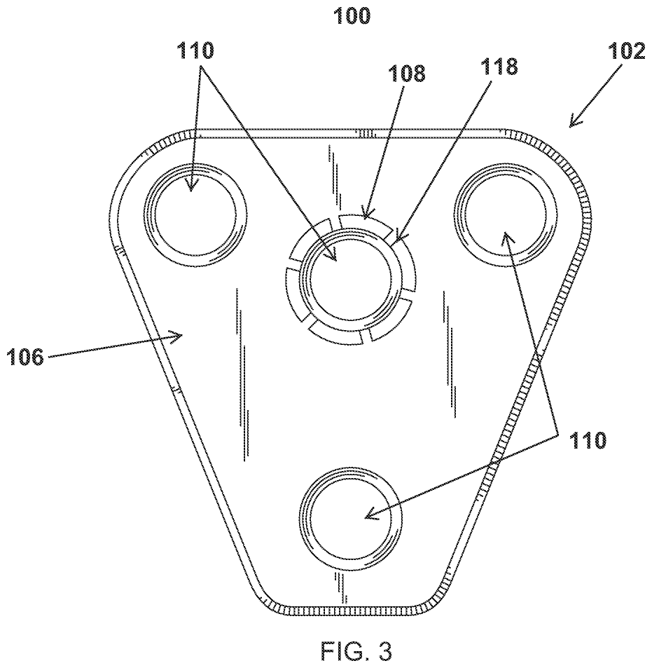

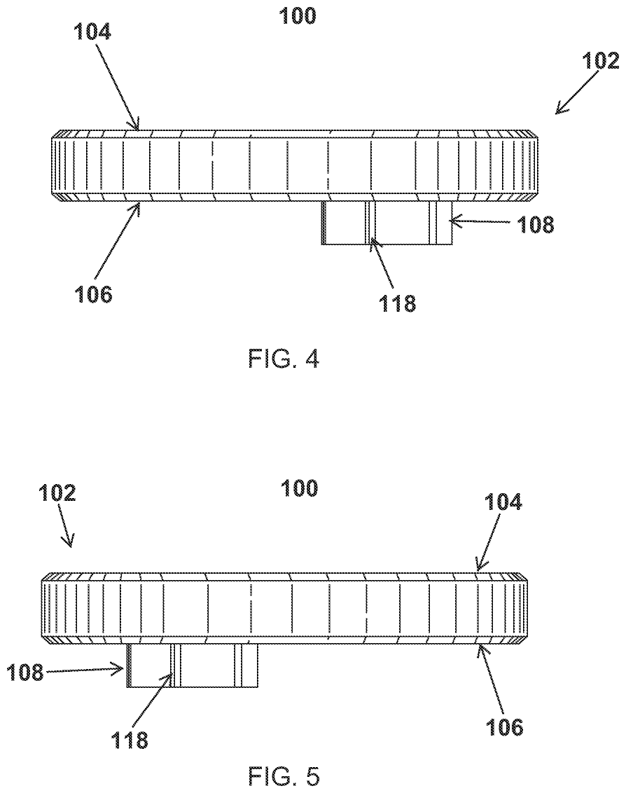

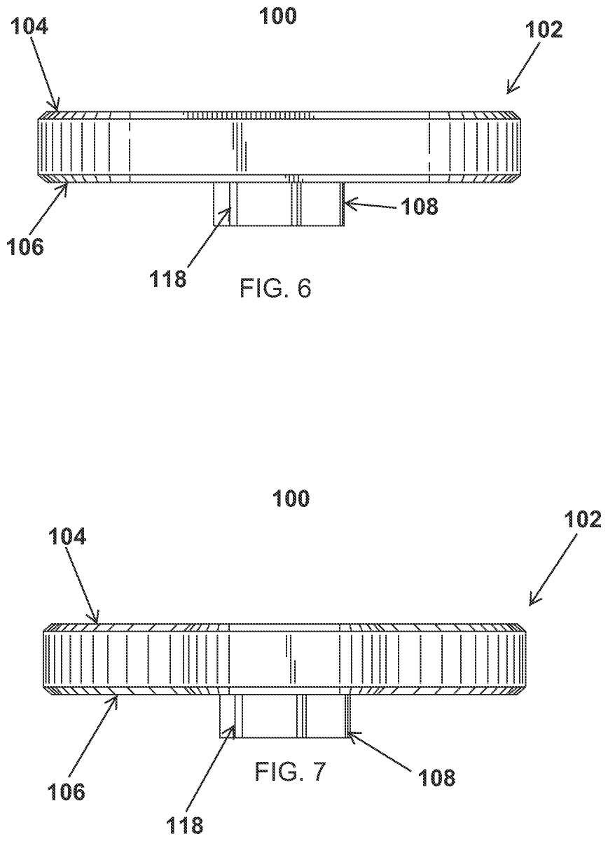

As seen in FIGS. 1 and 3, the bolt removal template 100 also comprises a flange 108. The flange 108 can be positioned adjacent to any aperture 110 on either the top 104 or bottom 106 of the plate 102. The flange 108 can have an annular member wherein the annular member is concentric or co-registered with the adjacent aperture 110. The diameter of flange 108 can be any size. It contemplated that the diameter of the flange 108 is the same as or larger than that of the adjacent aperture 110 such that the flange 108 will not fit through the aperture 110. The annular member of the flange 108 can also have at least one notch 118 formed in the peripheral portion of the annular member. The flange 108 can be made of any material capable of elastic deformation (e.g. nylon, rubber, polyurethane, polybutadiene, silicone, neoprene, etc.).

As seen in FIG. 8, the flange 108 can be secured to the plate 102 using a bolt 114 and mechanical fastener 116, or equivalent hardware. The bolt 114 used to secure the flange 108 can be any type and have any head style (e.g. flat, oval, hex, truss, button, etc.). In some embodiments, the bolt head is tapered such that the narrowest portion of the bolt head is adjacent to the bolt body. It is contemplated that the size of the bolt head can be large enough such that the bolt head retains the flange 108 even as the flange 108 deforms. In some embodiments, the bolt head can positioned within the flange 108. With the bolt head securing the flange 108 to the plate 102, the bolt body can extend through the adjacent aperture 110 with the end of the bolt body emerging from the top 104 of the plate 102. In some embodiments, the bolt body can have an external threaded portion. It is contemplated that the adjacent aperture 110 can have a complementary internal threaded portion 112 for receiving the external threaded portion of the bolt 114. The mechanical fastener 116 can be configured to the portion of the bolt body that emerges from the top 104 of the plate 102. The mechanical fastener 116 can be any type (e.g. hex nut, wing nut, square nut, etc.). In some embodiments, the mechanical fastener 116 can have a complementary internal threaded portion for receiving the external threaded portion of the bolt 114. A washer 126 can be interposed between the top 104 of the plate 102 and the mechanical fastener 116.

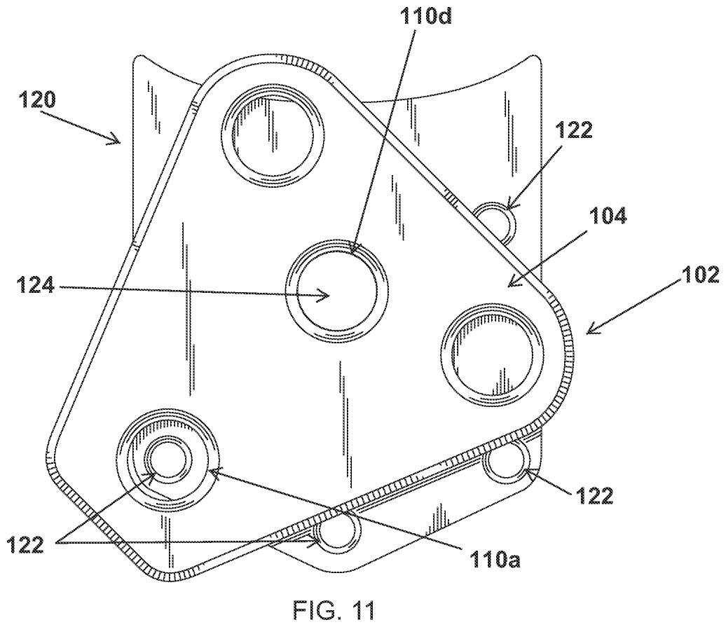

As seen in FIG. 8, the bolt removal template 100 can be configured engage with a fuel line 124 and bolt hole(s) 122 of a fuel tank housing 120. When the bottom 106 of the plate 102 is mounted onto the fuel tank housing 120, the flange 108 can be positioned inside the fuel line 124 such that the flange 108, the fuel line 124, and the adjacent aperture 110 are aligned or co-registered. As seen in FIGS. 10 and 11, the aperture aligned or co-registered with the fuel line 124 can be designated as the fuel line aperture 110d. The remaining aperture(s) on the plate 102 can be aligned or co-registered with a bolt hole 122 and designated as a bolt aperture 110(a-c). For example, as seen in FIG. 10, if three remaining apertures are aligned or co-registered with a bolt hole 122, the apertures can be designated as a first bolt aperture 110a, second bolt aperture 110b, and third bolt aperture 110c. As seen in FIG. 11, in some embodiments, at least one remaining aperture 110a can be aligned or co-registered with a bolt hole 122. In other embodiments, a plurality of remaining apertures 110(a-c) can be aligned or co-registered with a bolt hole 122.

As seen in FIG. 8, with the bolt removal template 100 mounted onto the fuel tank housing 120, the flange 108 can used to secure the plate 102 to the fuel tank housing 120. It is contemplated that when the plate 102 is secured, the plate 102 does not pivot relative to the fuel tank housing 120, and the bolt aperture(s) 110(a-c) remain aligned or co-registered with their respective bolt hole(s) 122. Securing the plate 102 to the fuel tank housing 120 can involve actuating the mechanical fastener 116 wherein the mechanical fastener 116 can threateningly engage with the bolt 114. Actuating the mechanical fastener 116 can allow the flange 108 to engage with the fuel line 124. In some embodiments, actuating the mechanical fastener 116 can involve drilling, screwing, twisting, etc. the mechanical fastener 116 up the bolt body towards the bolt head. It is contemplated that when the mechanical fastener 116 reaches the plate 102 or washer 126, further actuating the mechanical fastener 116 can pull the bolt head towards the bottom 106 of the plate 102. As the bolt head is pulled towards the plate 102, the bolt head can compresses the flange 108 such that the flange 108 expands in a direction R that is radial to the longitudinal axis A of the bolt 114—e.g., the flange 108 can be expandable. The material of the flange 108 and/or the notch(es) 118 can enable expansion of the flange 108 when compressed. Expansion of the flange 108 can cause the annular portion of the flange 108 to make contact with and/or at least partially obstruct the fuel line 124. It is contemplated that pressure and/or friction between the annular portion of the flange 108 and the fuel line 124 holds the plate 102 stationary relative to the fuel tank housing 120.

Additional means can be used cooperatively with or in lieu of the flange 108 to secure the bolt removal template 100 to the fuel tank housing 120. In some embodiments, bolt(s) or equivalent hardware can secure the bolt removal template 100 via bolt hole aperture(s) 110(a-c) and bolt hole(s) 122. The plate 102 can also be used for retaining the bolt removal template 100 using any suitable means (e.g. friction, hook and loop fasteners, straps, adhesives, magnets, etc.). For example, in some embodiments, plate 102 can be magnetic such that the plate 102 helps secure the bolt removal template 100 to the fuel tank housing 120.

An exemplary embodiment relates to a method for removing a failed bolt from a fuel tank housing 120 with a bolt removal template 100. As seen in FIG. 9, the fuel tank housing 120 can have a fuel line 124 and a bolt hole 122. In some embodiments, the fuel tank housing 120 can have a plurality of bolt holes 122. The embodiment of the bolt removal template 100 can have a plate 102 and a flange 108. The plate 102 can have a plurality of apertures 110. The plate 102 can have a top 104 and bottom 106. The flange 108 can be positioned on the bottom 106 of the plate 102 and adjacent to one of the apertures 110. The method can involve placing the plate 102 adjacent to the fuel tank housing 120 such that the flange 108 is positioned inside the fuel line 124 and one aperture 110 is aligned or co-registered with the bolt hole 122, the bolt hole 122 containing a failed bolt. In some embodiments, a plurality of apertures 110 are aligned or co-registered with a bolt hole 122, each bolt hole 122 containing a failed bolt. In some embodiments, the method can involve securing the bolt removal template 100 to the fuel tank housing 120. Securing the bolt removal template 100 can involve any one or combination of the aforementioned means. For example, in some embodiments, the method can involve causing the flange 108 to expand to secure the plate 102 to the fuel tank housing 120 and/or at least partially obstruct the fuel line 124. It is contemplated that securing the plate 102 to the fuel tank housing 120 can force at least one aperture 110 to be aligned or co-registered with a bolt hole 122 during actuation of the drill bit. The method can involve inserting a drill bit through an aligned or co-registered aperture 110 so as to make contact with the failed bolt. The method can involve actuating a drill bit. Actuating a drill bit can involve causing the drill bit to rotate about an axis of the drill bit and/or to move in a direction parallel to the axis of the drill bit. In some embodiments, actuating the drill can involve actuating a drill in mechanical connection with the drill bit. In some embodiments, actuating the drill bit can involve boring out at least a portion of the failed bolt. The method can involve allowing the bolt removal template 100 to maintain the drill bit in proper alignment before, during, and/or after actuation of the drill bit. Proper alignment can involve maintaining the drill bit at an orientation that is co-axial with the bolt hole 122 and/or preventing the drill bit from moving laterally so as to misalign or not co-register with the bolt hole 122. It is contemplated that the bolt removal template 100 can help the user drill out the failed bolt more efficiently without damaging the internal walls of the bolt hole 122.

It should be understood that modifications to the embodiments disclosed herein can be made to meet a particular set of design criteria. For instance, the number or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

1. A system comprising:
a DEF fuel tank housing comprising a fuel line and a bolt hole;
a bolt removal template comprising:
a plate, the plate having a plurality of apertures, the plate having a top and bottom; and
a flange, the flange positioned on the bottom of the plate and adjacent to one of the apertures;
wherein the plate is configured to engage with the DEF fuel tank housing; and
wherein, when the plate is engaged with the DEF fuel tank housing, the flange is positioned inside the fuel line.

2. The system of claim 1, wherein the plurality of apertures includes four apertures.

3. The system of claim 1, wherein at least one aperture has an internal threaded portion.

4-5. (canceled)

6. The system of claim 1, further comprising:
a threaded bolt positioned within the flange;
a mechanical fastener configured to threateningly engage the bolt;
wherein engaging the plate with the DEF fuel tank housing involves actuating the mechanical fastener.

7. The system of claim 1, wherein the flange comprises an annular member having a notch formed in a peripheral portion of the annular member.

8. The system of claim 1, wherein the flange comprises material capable of elastic deformation.

9. The system of claim 1, wherein the flange comprises nylon.

10. The system of claim 6, wherein actuating the mechanical fastener causes the flange to expand in a direction that is radial to a longitudinal axis of the threaded bolt.

11. The system of claim 10, wherein expansion of the flange secures the template to the DEF fuel tank housing and/or at least partially obstructs the fuel line.

12. The system of claim 8, wherein expansion of the flange holds the plate stationary relative to the DEF fuel tank housing.

13. The system of claim 1, wherein one aperture is aligned with the bolt hole.

14. The system of claim 1, wherein:
the plurality of apertures includes a first bolt aperture, a second bolt aperture, a third bolt aperture, and a fuel line aperture;
wherein:
each of the first bolt aperture, the second bolt aperture, and the third bolt aperture is positioned on the plate so as to align with a first bolt hole, a second bolt hole, and a third bolt hole, respectively, of the DEF fuel tank housing when the plate bottom is placed adjacent to the DEF fuel tank housing; and
the fuel line aperture is positioned on the plate so as to align with a fuel line of the DEF fuel tank housing when the plate bottom is placed adjacent to the DEF fuel tank housing.

15. A method for removing a failed bolt from a fuel tank housing with a bolt removal template, the fuel tank housing having a fuel line and a bolt hole, the bolt removal template comprising: a plate, the plate having a plurality of apertures, the plate having a top and bottom; and a flange, the flange positioned on the bottom of the plate and adjacent to one of the apertures, the method comprising:
placing the plate adjacent to the fuel tank housing such that the flange is positioned inside the fuel line and one aperture is aligned or co-registered with the bolt hole, the bolt hole containing a failed bolt;
inserting a drill bit through the aligned or co-registered aperture so as to make contact with the failed bolt;
allowing the bolt removal template to maintain the drill bit in proper alignment before, during, and/or after actuation of the drill bit;
wherein actuating the drill bit involves causing the drill bit to rotate about an axis of the drill bit and/or to move in a direction parallel to the axis of the drill bit;
wherein proper alignment includes: maintaining the drill bit at an orientation that is co-axial with the bolt hole and/or preventing the drill bit from moving laterally so as to misalign or not co-register with the bolt hole; and
actuating the drill bit.

16. The method of claim 15, further comprising securing the plate to the fuel tank housing.

17. The method of claim 16, wherein securing the plate to the fuel tank housing forces the one aperture to be aligned or co-registered with the bolt hole during actuation of the drill bit.

18. The method of claim 15, wherein actuating the drill bit bores out at least a portion of the failed bolt.

19. The method of claim 15, wherein actuating the drill involves actuating a drill in mechanical connection with the drill bit.

20. The method of claim 15, further comprising causing the flange to expand to secure the plate to the fuel tank housing and/or at least partially obstruct the fuel line.

21. The system of claim 1, wherein the DEF fuel tank housing is configured to receive a doser valve via the bolt hole.
